(19) United States
(12) Patent Application Publication
(10) Pub. No.: US 2010/0293547 A1
(43) Pub. Date: Nov. 18, 2010

(54) INFORMATION PROCESSING APPARATUS, METHOD FOR CONTROLLING INFORMATION PROCESSING APPARATUS, AND PROGRAM

(75) Inventor: Yoshikazu Hayami, Fuchu-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/766,838

(22) Filed: Apr. 23, 2010

(30) Foreign Application Priority Data
May 14, 2009 (JP) 2009-118039

(51) Int. Cl. G06F 9/46

(52) U.S. Cl. 718/102

(57) ABSTRACT

A loss of convenience that may occur when a process flow usable by a specific user is registered as a process flow commonly usable by multiple users is reduced. To accomplish this, an information processing apparatus includes a registration unit that registers a process flow for executing predetermined processing according to a predefined set value, the process flow being registered as a process flow that is usable by a specific user or a process flow that is commonly usable by a plurality of users, a changing unit that changes the process flow that is usable by the specific user to the process flow that is usable by the plurality of users, and a control unit that, when the changing unit changes the process flow, allows a user to change the set value to another set value.

### BACKGROUND OF THE INVENTION

1. Field of the Invention

The present invention relates to an information processing apparatus, a method for controlling an information processing apparatus, and a program.

2. Description of the Related Art

An information processing apparatus has been proposed that enables settings to execute multiple processes relevant to image data, using an apparatus connected to a network. For example, Japanese Patent Laid-Open No. 2004-287860 proposes a method for reusing settings relating to the cooperation of multiple processes in other external apparatuses. Specifically, Japanese Patent Laid-Open No. 2004-287860 proposes a configuration in which instruction data that enables multiple processes to cooperate is generated, and this instruction data is made usable by other external apparatuses or other users.

Note that, in the following description, those processes that are to cooperate with each other are referred to as “tasks”. The term “task” as used herein refers to, for example, a process that may be implemented by an individual function of an apparatus such as an image forming apparatus that has multiple functions, or an individual process that may be implemented in an application executed by an information processing apparatus or the like. Examples of tasks in an image forming apparatus include scanning an original, storing scanned data, transmitting an e-mail, transmitting a facsimile, and printing, for example. A task cooperation processing procedure(a process flow) refers to a combination of a series of tasks that is created by connecting multiple tasks as described above for the purpose of processing the tasks in chronological order. For the combination, various combination processes are possible, including use of one task result as an input to execute another task.

FIG. 1 is a diagram explaining a method for registering a task cooperation processing procedure. As illustrated in FIG. 1, processing contents are registered in tasks 101, 102, and 103. The task cooperation processing procedure illustrated in FIG. 1 also indicates that the tasks 101, 102, and 103 are processed in the order described. Thus, a user can select and define a task in the processing procedure. At that time, a user can not only designate the combination and order of tasks but also designate detailed settings for processing in individual tasks. For example, one conceivable procedure in an image forming apparatus is to do a scan, store the scanned contents into a hard disk of the image forming apparatus, and send the contents by e-mail to the designated destination. At this time, detailed setting items are required, such as a folder to save and an e-mail destination. In the following description, such set values that are required to execute a task are referred to as “parameters”.

Also, in an information processing apparatuses or an image forming apparatuses such as a computer, personal authentication (hereinafter referred to as “login”) may be performed at the time of use in some cases. Moreover, such an apparatus may include a user area that is only usable by a logged in user and a shared area that is commonly usable by multiple users. A task cooperation processing procedure may also include two types of usage, a task cooperation processing procedure for a logged in user that is only usable by a logged in user and a task cooperation processing procedure for shared use that is commonly usable by multiple users.

FIG. 2 illustrates a storage area in an information processing apparatus or an image forming apparatus. As illustrated in FIG. 2, the definition of a task cooperation processing procedure for a logged in user is stored as user groups 206, 207, and 208 in user areas 201, 202, and 203 for users on a hard disk. Meanwhile, the definition of a task cooperation processing procedure for shared use is stored as one shared group 205 of a shared area 204. A task cooperation processing procedure that belongs to the “shared group” is executed by being invoked by multiple users and from multiple image forming apparatuses or information processing apparatuses. That is, a task cooperation processing procedure that belongs to the “shared group” is used from various places and by various users.

As described above, the technique for making a task cooperation processing procedure public to other users has been proposed, but it faces the following challenge. For example, in a task cooperation processing procedure that has been defined and registered by a user, individual tasks in the procedure include various parameters as mentioned above. In particular, in a task cooperation processing procedure that is mainly performed by an image forming apparatus, such parameters in the tasks play important roles. Thus, if a task cooperation processing procedure is registered and used without ascertaining the states of parameters, a result not intended by the user is very likely to be output. Thus, for a task cooperation processing procedure that is mainly performed by an image forming apparatus, it is very difficult to use a procedure defined by another user.

For example, even though the order or combination of tasks in a task cooperation processing procedure matches the procedure as expected, the settings for a task therein, for example, the settings for an output process such as printing, may differ from what is expected, such as where the number of copies to be printed is different from the desired number. Or in another case, the destination to save scanned data may not be any of the folders under one's own control. In such cases, the user may not attain the desired result.

It is generally apparent that the combination and order of tasks, in other words, a procedure tree structure, is important for a task cooperation processing procedure. However, it can also be seen from the above description that, for example in a task cooperation processing procedure that is mainly performed by an image forming apparatus, set parameters of each task are no less important than the tree structure. To address such an issue, Japanese Patent Laid-Open No. 2007-129580 has proposed a technique for registering a new task cooperation processing procedure so as to be usable by all users and with parameters in the task cooperation processing procedure changed according to use conditions of each user.

However, the above-described conventional technique has the problem described below. One example of the problem will be described with reference to FIG. 4. FIG. 4 illustrates an operation for storing a task cooperation processing procedure. Reference numeral 401 denotes a process performed by a user for registering one task cooperation processing procedure. Reference numeral 402 denotes a process for registering a task cooperation processing procedure, in which the task cooperation processing procedure is registered at once into user areas of all registered users so as to adapt to use conditions of each user. The registration process 402 is the process of automatically setting the setting contents for each task. Different from the registration process 402, reference numeral 403 denotes a process of selecting and registering the setting contents for each task. Reference numeral 404 denotes a copy-source task cooperation processing procedure 1. Reference numerals 405 and 406 denote task cooperation processing procedures 1-2 and 1-N, respectively, that have been copied from the task cooperation processing procedure 1 with some of the setting parameters being changed according to use conditions of each user.

In the registration process 403, however, only a user 1 who has registered the task cooperation processing procedure 1 can select setting contents, in other words, the selection cannot be made by other users. Here, even though the user 1 could select registration contents that correspond to other users 2, 3, . . . , N at the time of registration, it would be uncertain for the user 1 how the user 2 wants to operate the task cooperation processing procedure 1_2, for example. Thus, if the person who registers a task cooperation processing procedure differs from the person who executes the procedure, it might not be effective even though the registered person (user 1) can select setting contents for the executor (user 2). Also, user-specific settings cannot be made even though a common task cooperation processing procedure is defined in a shared area.

The following cases are conceivable as the case described above where a person who registers a task cooperation processing procedure differs from a person who executes the procedure. For example, one conceivable case is where, for the purpose of one's own use, a logged in user copies the contents of a task cooperation processing procedure created by another user into his or her own “user group” and uses the copied task cooperation processing procedure. Another conceivable case is where, for the purpose of common use by multiple users, a third party with administrative rights copies the contents of a task cooperation processing procedure created by any other user into a “shared group”, and each logged in user uses the copied task cooperation processing procedure.

### SUMMARY OF THE INVENTION

The present invention enables realization of a mechanism that reduces a loss of convenience when registering an instruction unit that is only usable by a specific user, as an instruction unit that is commonly usable by multiple users.

One aspect of the present invention provides an information processing apparatus comprising: a registration unit that registers a process flow for executing predetermined processing according to a predefined set value, the process flow being registered as a process flow that is usable by a specific user or a process flow that is commonly usable by a plurality of users; a changing unit that changes the process flow that is usable by the specific user to the process flow that is usable by the plurality of users; and a control unit that, when the changing unit changes the process flow, prompts a user to change the set value to another set value.

Another aspect of the present invention provides an information processing apparatus comprising: a registration unit that registers a process flow for executing predetermined processing according to a predefined set value, the process flow being registered as a process flow that is usable by a specific user or a process flow that is commonly usable by a plurality of users; a changing unit that changes the process flow that is usable by the plurality of users to the process flow is usable by the specific user; and a control unit that, when the changing unit changes the process flow, prompts a user to change the set value to another set value.

Still another aspect of the present invention provides an information processing apparatus comprising: a registration unit that registers a process flow for executing predetermined processing according to a predefined set value, the process flow being registered as a process flow that is usable by a first user or a process flow that is usable by a second user; a changing unit that changes the process flow that is usable by the first user to the process flow that is usable by a second user; and a control unit that, when the changing unit changes the process flow, prompts a user to change the set value to another set value.

Yet another aspect of the present invention provides a method for controlling an information processing apparatus, comprising: registering a process flow for executing predetermined processing according to a predefined set value, the process flow being registered as a process flow that is usable by a specific user or a process flow that is commonly usable by a plurality of users; changing the process flow that is usable by the specific user to the process flow that is usable by the plurality of users; prompting, when the process flow is changed, a user to change the set value to another set value.

Still yet another aspect of the present invention provides a method for controlling an information processing apparatus, comprising: registering a process flow for executing predetermined processing according to a predefined set value, the process flow being registered as a process flow that is usable by a specific user or a process flow that is commonly usable by a plurality of users; changing the process flow that is usable by the plurality of users to the process flow is usable by the specific user an instruction unit that has been stored in the storage unit as an instruction; and prompting, when the process flow is changed, a user to change the set value to another set value.

Yet still another aspect of the present invention provides a method for controlling an information processing apparatus, comprising: registering a process flow for executing predetermined processing according to a predefined set value, the process flow being registered as a process flow that is usable by a first user or a process flow that is usable by a second user; changing the process flow that is usable by the first user to the process flow that is usable by a second user; and prompting when the process flow is changed, a user to change the set value to another set value.

Still yet another aspect of the present invention provides a computer-readable storage medium storing a computer program for causing a computer to perform the method for controlling an information processing apparatus.

Further features of the present invention will be apparent from the following description of exemplary embodiments with reference to the attached drawings.

### BRIEF DESCRIPTION OF THE DRAWINGS

FIG. 1 is a diagram explaining a method for registering a task cooperation processing procedure.

FIG. 2 illustrates a storage area in an information processing apparatus or an image forming apparatus.

FIG. 3 illustrates a task cooperation processing procedure defined in XML format according to an embodiment of the present invention.

FIG. 4 illustrates an operation for storing a task cooperation processing procedure.

FIG. 5 is a block diagram illustrating an overall configuration of an image forming system according to an embodiment of the present invention.

FIG. 6 is a block diagram illustrating a configuration that controls an image forming apparatus according to an embodiment of the present invention.

FIG. 7 illustrates an example configuration of a software module of an image forming apparatus 510 according to an embodiment of the present invention.

FIG. 8 illustrates a setting screen presented to a user for setting a task cooperation processing procedure according to an embodiment of the present invention.

FIG. 9 is a diagram explaining a method for registering a task cooperation processing procedure according to an embodiment of the present invention.

FIG. 10 illustrates users and task cooperation processing procedures that may be used according to an embodiment of the present invention.

FIG. 11 is a diagram explaining the process of copying a task cooperation processing procedure according to an embodiment of the present invention.

FIG. 12 is a flow chart showing a procedure for copying and executing a task cooperation processing procedure according to a first embodiment.

FIG. 13 is a flow chart showing a procedure for the process of copying a task cooperation processing procedure according to the first embodiment.

FIG. 14 illustrates an example of a change confirmation screen 1400 according to the first embodiment.

FIG. 15 illustrates the process of converting an XML data file according to the first embodiment.

FIGS. 16A and 16B are flow charts showing a procedure for the process of executing a task cooperation processing procedure according to a second embodiment.

FIG. 17 illustrates the process of converting an XML data file according to the second embodiment.

FIG. 18 illustrates a setting screen 1800 according to a third embodiment.

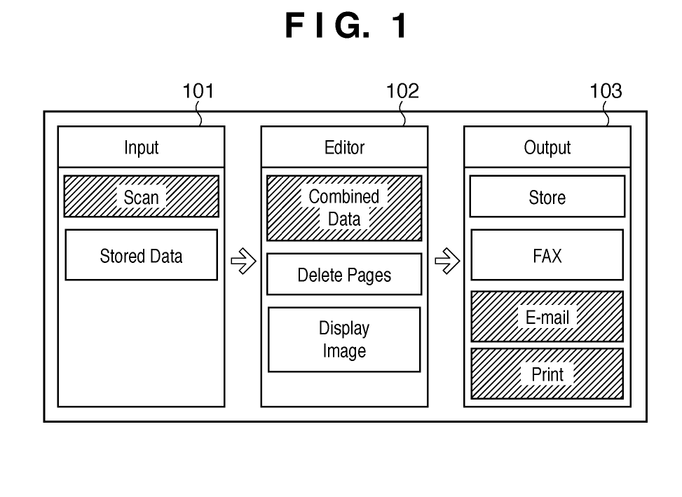

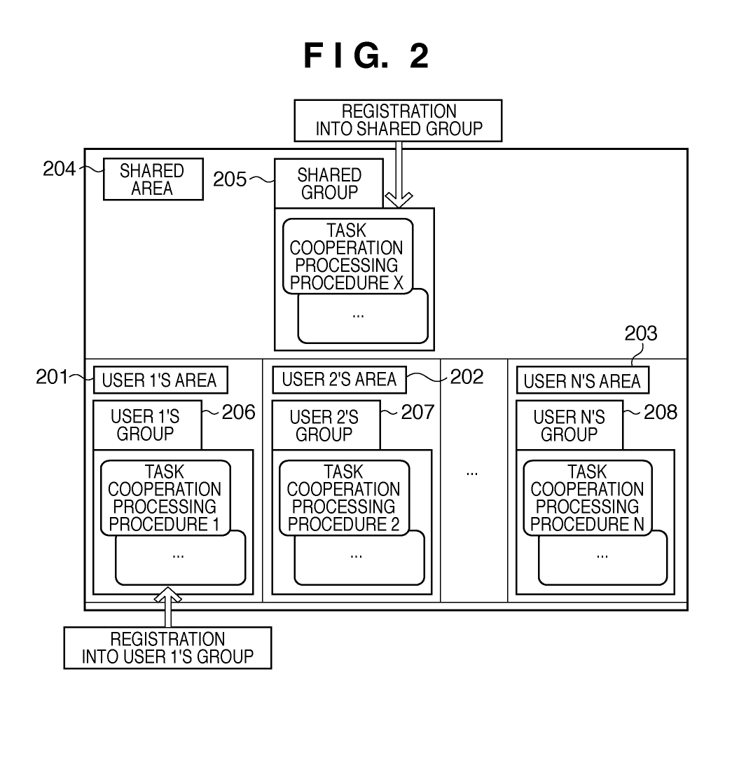

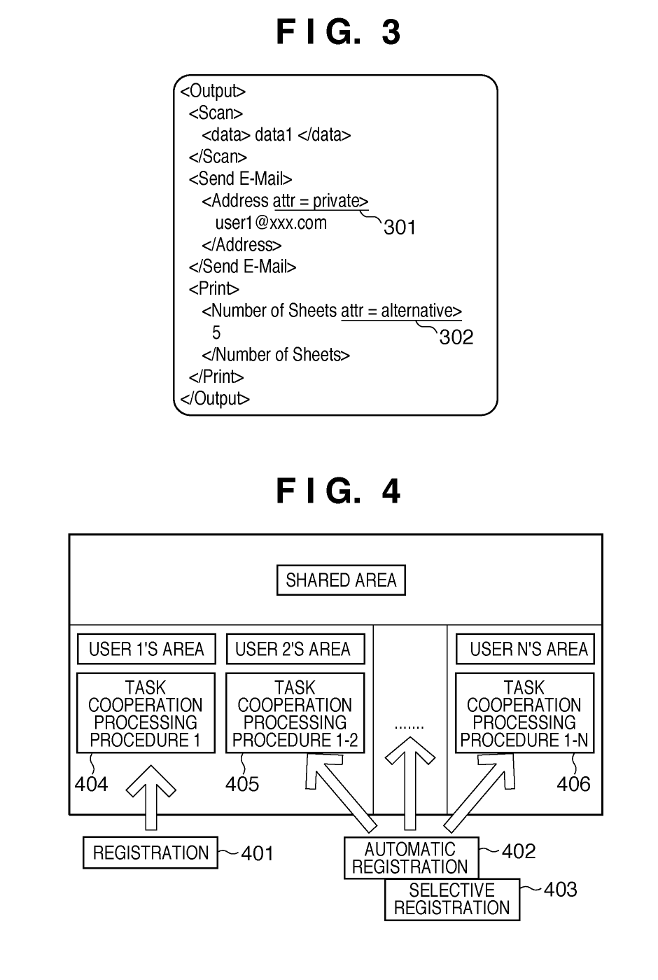

### DESCRIPTION OF THE EMBODIMENTS

Embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### Configuration of Image Forming System

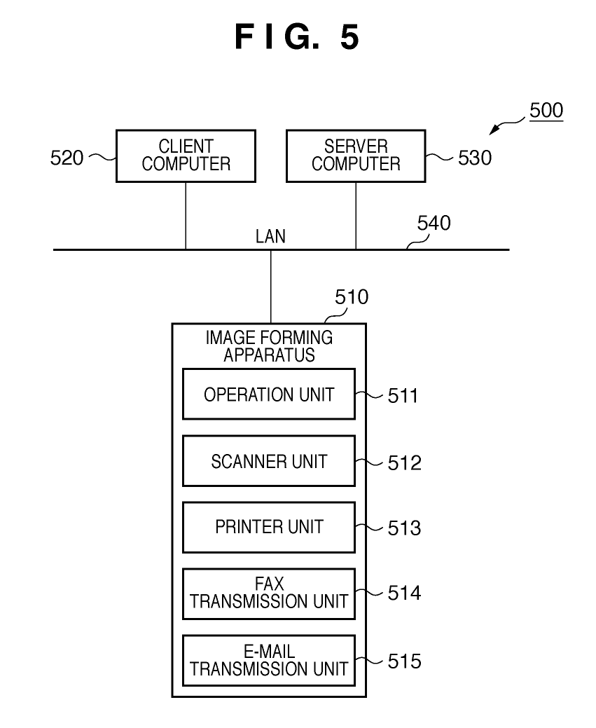

First, an image forming system according to an embodiment of the present invention will be described with reference to FIG. 5. In an image forming system 500, an image forming apparatus 510, a client computer 520, and a server computer 530 are connected via a LAN 540 such as Ethernet®. In the present example, a single image forming apparatus, a single client computer, and a single server computer are connected to one another. However, the present invention is also applicable to a system that includes multiple image forming apparatuses and multiple computers, which are connected to one another.

The image forming apparatus 510 has a copy function, a facsimile function, an e-mail transmission function, and a data transmission function for reading an original image and transmitting the read image data to apparatuses on the LAN 540. The image forming apparatus 510 is also capable of storing an image that has been read from an original image or data that has been received from a computer connected on the LAN 540 into a specific area in a hard disk of the image forming apparatus 510. The apparatus is also capable of reading and storing an original image as a digital image into the hard disk as well as printing such a digital image.

The image forming apparatus 510 includes an operation unit 511, a scanner unit 512 as an image input device, a printer unit 513 as an image output device, a FAX transmission unit 514 that transmits a facsimile, and an e-mail transmission unit 515 that transmits an e-mail. The scanner unit 512 inputs reflected light obtained by exposing and scanning an image on an original into a CCD and thereby converts image information into an electric signal. The scanner unit 512 further converts the electric signal into luminance signals of colors R, G, and B and outputs the luminance signals as image data to a controller 600. Specifically, when a user gives an instruction from the operation unit 511 to start reading, the controller 600 gives an instruction to the scanner unit 512 to read an original set on an original feeder. Upon receipt of the instruction, the scanner unit 512 feeds the original sheet by sheet from the original feeder to read the original. Note that the method for reading an original is not necessarily an automatic feeding method using an original feeder, and it may be a method for placing an original on a glass surface not shown and scanning the original by moving an exposure unit. The printer unit 513 is an image forming device that forms image data received from the controller 600 as described later on paper. The server computer 530 performs various data processing by the CPU executing an operating system (hereinafter referred to as the “OS”) or various application programs (APs) so that applications run under the control of the OS. The same applies to the client computer 520.

### Configuration of Image Forming Apparatus

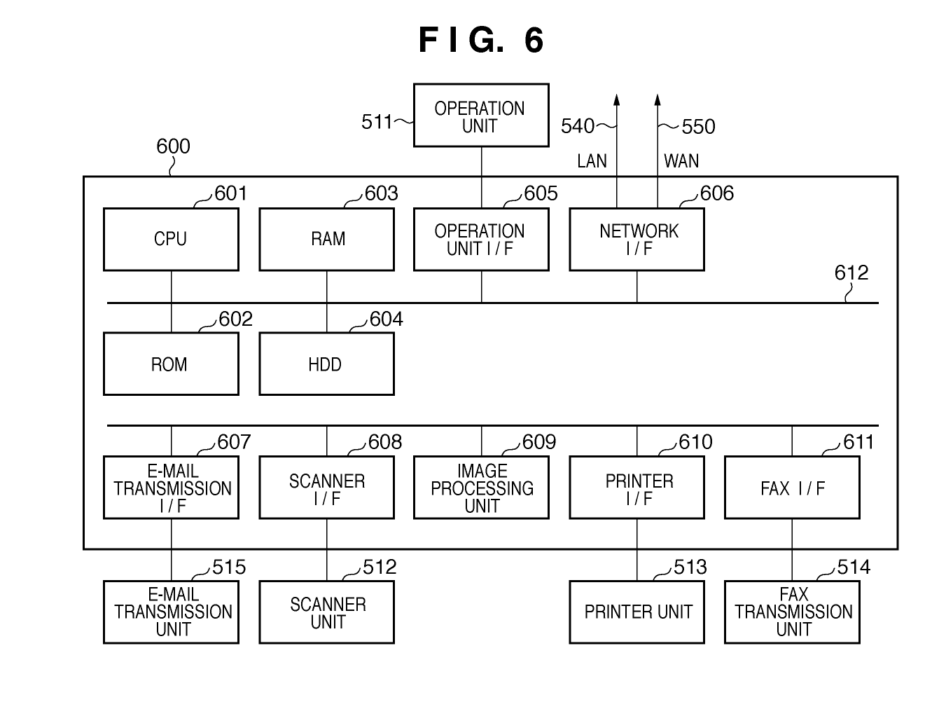

Next, a configuration for controlling the image forming apparatus 510 will be described with reference to FIG. 6. The following description is mainly for the control blocks that are relevant to the present invention. The image forming apparatus according to the present invention may of course be configured to include any other control blocks. The image forming apparatus 510 includes the controller 600 that provides centralized control over the whole apparatus. The controller 600 is electrically connected to the scanner unit 512 and the printer unit 513 and is also connected via the LAN 540 to the client computer 520 and the server computer 530. Such connections allow the controller 600 to control input and output of image data and device information.

The controller 600 includes a CPU 601, a ROM 602, a RAM 603, a HDD 604, and an operation unit I/F (interface) 605. The controller 600 also includes a network I/F 606, an e-mail transmission I/F 607, a scanner I/F 608, an image processing unit 609, a printer I/F 610, and a FAX I/F 611. Each block is connected via a system bus 612 to the other blocks. The CPU 601 provides centralized control over accesses to various connected devices based on a control program or the like stored in the ROM 602 as well as providing centralized control over various processing performed in the controller 600.

The ROM 602 stores a boot program or the like for the apparatus. The RAM 603 serves as a system work memory for the CPU 601 to operate and also serves as a memory for temporarily storing image data. The RAM 603 is constituted by an SRAM that holds stored contents after power-off or a DRAM that deletes stored contents after power-off, for example. The HDD 604 is a hard disk drive that stores system software or image data.

The operation unit I/F 605 is an interface for connecting the system bus 612 and the operation unit 511. The operation unit I/F 605 receives and outputs image data to be displayed on the operation unit 511 via the system bus 612, and outputs information that has been input from the operation unit 511 to the system bus 612. The network I/F 606 is connected to the LAN 540, a WAN 550, and the system bus 612 in order to input and output information. The scanner I/F 608 corrects, processes, and edits image data that has been received from the scanner unit 512. Note that the scanner I/F 608 determines whether the received image data is a color original or a black and white original, whether received image data is a document original or a photograph original, and so on. The determination results are then associated with the image data. Such associated information is referred to as “attribute data”.

The image processing unit 609 performs image processing such as changing the direction of image data and compressing or expanding an image. The printer I/F 610 receives image data that has been transmitted from the image processing unit 609, performs image processing while referring to the attribute data associated with the image data, and outputs resultant data to the printer unit 513.

The FAX I/F 611 outputs image data that has been transmitted from the image processing unit 609 to the FAX transmission unit 514, and transmits the image data via the LAN 540 or the WAN 550 to the designated transmission destination. The mail I/F 607 outputs image data that has been transmitted from the image processing unit 609 to the e-mail transmission unit 515, which then transmits the image data via the LAN 540 or the WAN 550 to the designated transmission destination.

Note that the presentation of user instructions to the image forming apparatus 510 or the presentation of information to a user may be made through the operation unit 511 or through the client computer 520 connected via the LAN 540, for example.

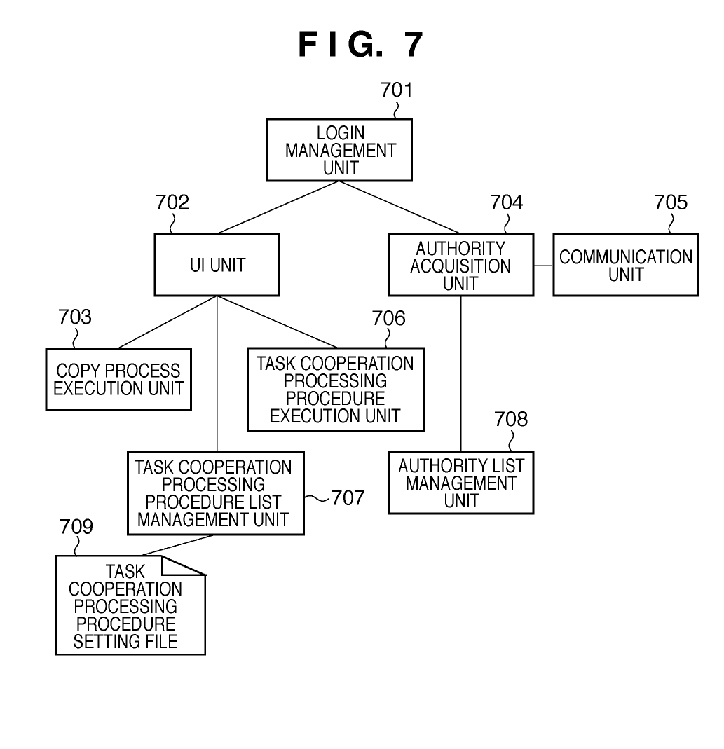

Next, the configuration of a software module of the image forming apparatus 510 will be described with reference to FIG. 7. Note that, while the software module is described in the present example, the functions as described below may be implemented by hardware or a combination of hardware and software.

The software module processing illustrated in FIG. 7 is implemented by the CPU 601 reading and executing various programs stored in the ROM 602. Also, the functions executed by the image forming apparatus 510 according to the present invention are not particularly limited as long as they are those functions that are provided by an image forming apparatus, such as a print function, a copy function, a scan function, a data transmission function, and a book-binding function.

A login management unit 701 receives login information about a user as an operator from an UI unit 702 and manages user sessions. The UI unit 702 provides display on the operation unit 511 via the operation unit I/F 605 or processes a user input from the operation unit 511. An authority acquisition unit 704 makes an inquiry to the server computer 530 about access control information regarding whether or not a user is allowed to use the functions of the image forming apparatus 510. An authority list management unit 708 manages access control information for logged in users. A copy process execution unit 703 copies a task cooperation processing procedure setting file 709 into a shared area or user areas of other users in the HDD 604. A communication unit 705 provides communication by operating the network I/F 606.

A task cooperation processing procedure execution unit 706 splits the procedure into task settings in functional units (for example, scan task settings, print task settings, transmission task settings) and executes actual processing in the order of the list of the task cooperation processing procedure. A task cooperation processing procedure list management unit 707 manages the task cooperation processing procedure setting file 709 (which may be in XML). It also manages information indicating which “procedure EXECUTE button” (also referred to as a “procedure EXECUTE key”) is to be displayed on the operation unit 511 at the time of user login.

### Task Cooperation Processing Procedure (A Process Flow)

A task cooperation processing procedure (a process flow) registered in the image forming apparatus 510 is defined through the operation unit 511, and regular work procedures for each user may be registered in advance. Examples of functions that may be registered as tasks displayed on an operation panel of the operation unit 511 will be described below: (1) input functions (an original scan function and a scanned-data storage function); (2) processing functions (a scanned-data editing function and an image display function); and (3) output functions (an e-mail transmission function for scanned data, a fax function, and a print function). A combination of any of those functions defines a task cooperation processing procedure.

Referring to, for example, an e-mail transmission function as an output function from among the functions of a task cooperation processing procedure, a case is conceivable where a user who has logged in the image forming apparatus 510 transmits scanned data by e-mail to a specified destination. In this case, the logged in user may acquire and set a parameter (set value) of his or her own e-mail transmission destination from a network server or an address book that has been registered in the HDD 604 of the image forming apparatus 510.

Next, a method for generating a task cooperation processing procedure according to an embodiment of the present invention will be described with reference to FIG. 3. As illustrated in FIG. 3, a task cooperation processing procedure is defined in a format such as XML, for example. As illustrated herein, XML contains tags that define tasks, and parameters used in the tasks are defined in the tags. As illustrated in FIG. 3, in the present embodiment, an attribute symbol 301 (for example, “private” in the present example) indicating that the data is user-specific information is automatically appended to the attribute of a data tag that is considered as individual data such as an e-mail destination in the XML data. Whether or not to append the “private” attribute is determined depending on whether or not concerned data is a parameter that is defined as user-tied information by the network server or the HDD 604. For example, an e-mail address or the like is determined as the “private” attribute, because the address is contained in the address book in the HDD 604. Here, such a “private” attribute may be appended by a user in advance to data.

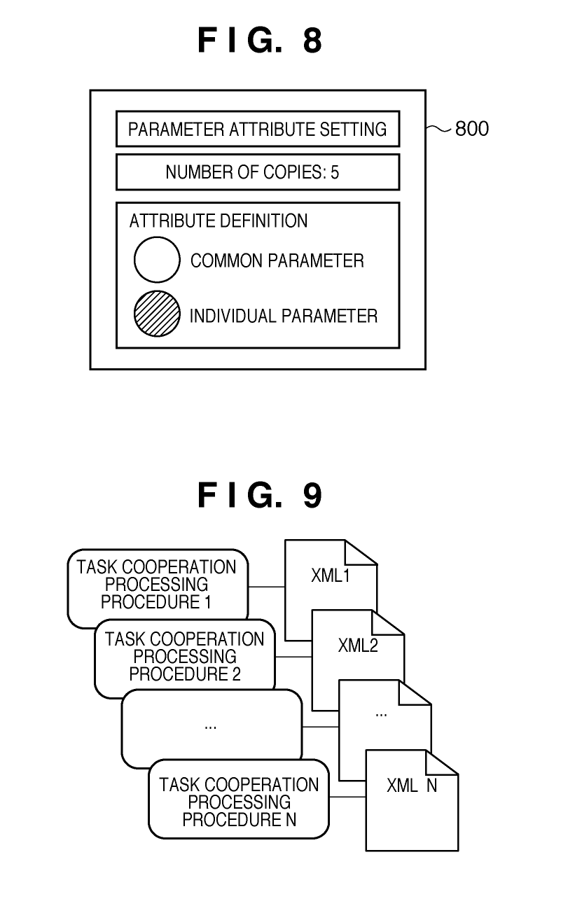

Also, if a parameter may have a different value for each user even though the parameter is not tied to each user, an attribute symbol 302 indicating that fact (for example, “alternative” in the present example) may be appended by a user to each such parameter. FIG. 8 illustrates a setting screen (operation screen) that is presented to a user for setting a task cooperation processing procedure according to the present embodiment. A setting screen 800 is displayed on a display of the operation unit 511. As shown by the setting screen 800, a user is allowed to set an attribute of each parameter that indicates whether the parameter is a common parameter or an individual parameter. FIG. 9 is a diagram explaining a method for registering a task cooperation processing procedure according to the present embodiment. As illustrated in FIG. 9, according to the present embodiment, a task cooperation processing procedure is registered in one-to-one correspondence with XML data that is defined as the task cooperation processing procedure setting file 709.

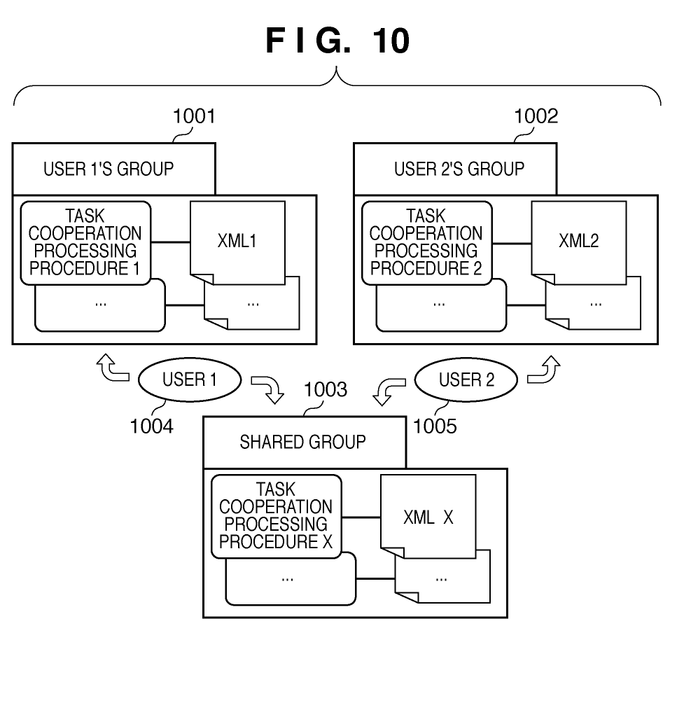

Next, the task cooperation processing procedure that can be used by each user will be described with reference to FIG. 10. As illustrated in FIG. 10, a user 1004 (user 1) who has logged into the image forming apparatus 510 can use a task cooperation processing procedure that belongs to a user 1's group 1001 and a task cooperation processing procedure that belongs to a shared group 1003. Similarly, a logged in user 1005 (user 2) can use a task cooperation processing procedure that belongs to a user 2's group 1002 and a task cooperation processing procedure that belongs to the shared group 1003. In this way, a task cooperation processing procedure that belongs to each user group is usable by a specific user, whereas a task cooperation processing procedure that belongs to the shared group is commonly usable by multiple users. Thus, in the case where the user 2 wants to use a task cooperation processing procedure that belongs to the user 1's group 1001, it is necessary to copy the task cooperation processing procedure into either the shared group 1003 or the user 2's group 1002. That is, a task cooperation processing procedure that belongs to the user 1's group 1001 and is usable by the user 1 becomes usable by the user 2, by copying the task cooperation processing procedure into either the shared group or another user group.

### Process of Copying Task Cooperation Processing Procedure

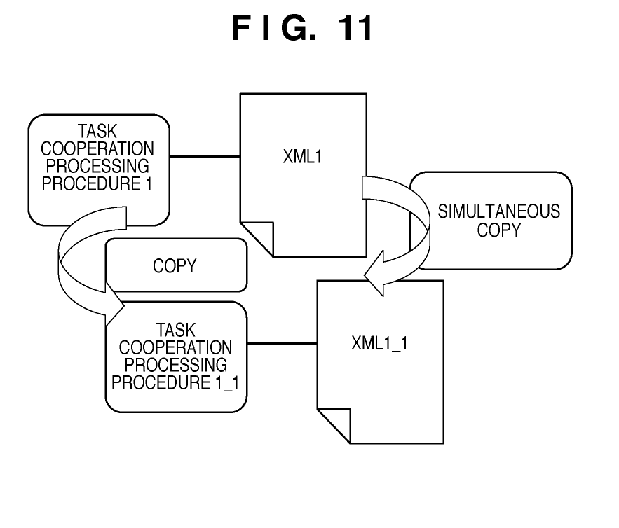

Next, the process of copying a task cooperation processing procedure will be described with reference to FIG. 11. As illustrated in FIG. 11, in the process of copying a task cooperation processing procedure, XML data that is in one-to-one correspondence with the task cooperation processing procedure is also copied simultaneously with copying the task cooperation processing procedure. Copying a task cooperation processing procedure in this way allows other users to simply use the same function.

However, if parameter information that is effective only for individuals is copied with as-is values, a task cooperation processing procedure will be defined that includes setting parameters that are possibly ineffective for other users. For example, let us assume that a task cooperation processing procedure defined for a user includes a setting of his or her own destination, user1@xxx.com, as a destination for the transmission function. The user can transmit data to his or her own mail destination by executing the cooperation processing procedure. If this task cooperation processing procedure is copied including the as-is value of the setting parameter, the value of user1@xxx.com is also copied as is to the XML data that defines the copied task cooperation processing procedure. Thus, in the case where another user 2 uses this copied task cooperation processing procedure, the setting is such that data is transmitted not to his or her own mail address (the mail address of the user 2) but to the address of the user 1. It is generally desirable that, in the case where the user 2 uses a procedure, parameters therein are set such that data is transmitted to the user 2. Thus, simply copying a procedure is insufficient to satisfy practical functional needs. Now, embodiments that solve the problems as described above will be described.

### First Embodiment

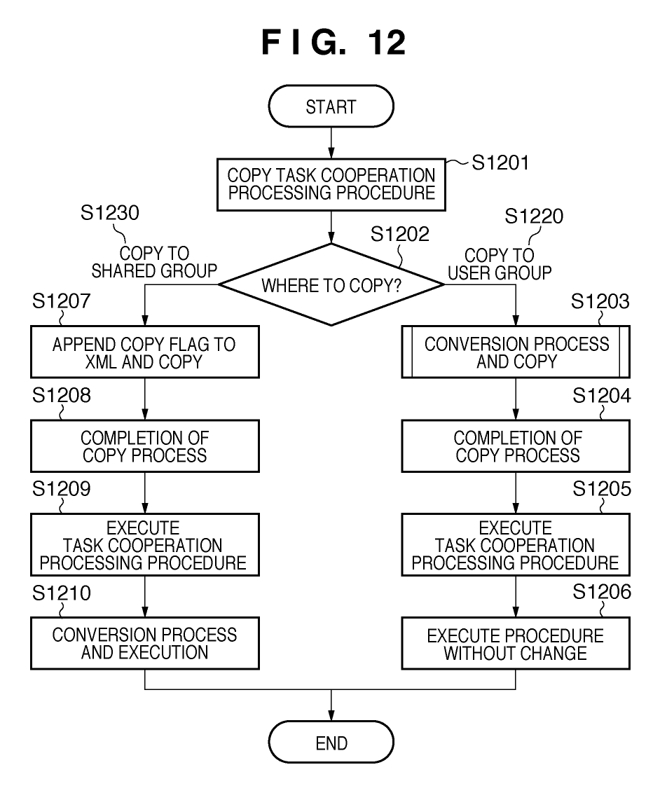

A first embodiment will be described below with reference to FIGS. 12 to 15. In the present embodiment, a case is assumed where a person who registers a task cooperation processing procedure differs from a user of the procedure. For example, a conceivable case is where, for the purpose of own use, a logged in user copies a task cooperation processing procedure created by another user into his or her own “user group” and uses the copied task cooperation processing procedure. In the following description, as an example, a case is considered where a task cooperation processing procedure that has been defined by a user 1 for transmitting scanned data by e-mail to the user 1's own destination and printing the data is copied by a user 2 into the user 2's own user group.

Referring to FIG. 12, a procedure for copying and executing a task cooperation processing procedure according to the first embodiment will be described. The processing described below is under the centralized control of the CPU 601 of the image forming apparatus 510. First, in step S1201, the CPU 601 starts a copy of a task cooperation processing procedure. Then, in step S1202, the CPU 601 determines which area to copy the specified task cooperation processing procedure to. Specifically, it is determined whether the procedure is copied to a shared group or to any user group. If the procedure is copied to a shared group, the process proceeds to step S1207, and if the procedure is copied to a user group, the process proceeds to step S1203. Note that steps S1207 to S1210 will be described later in a second embodiment.

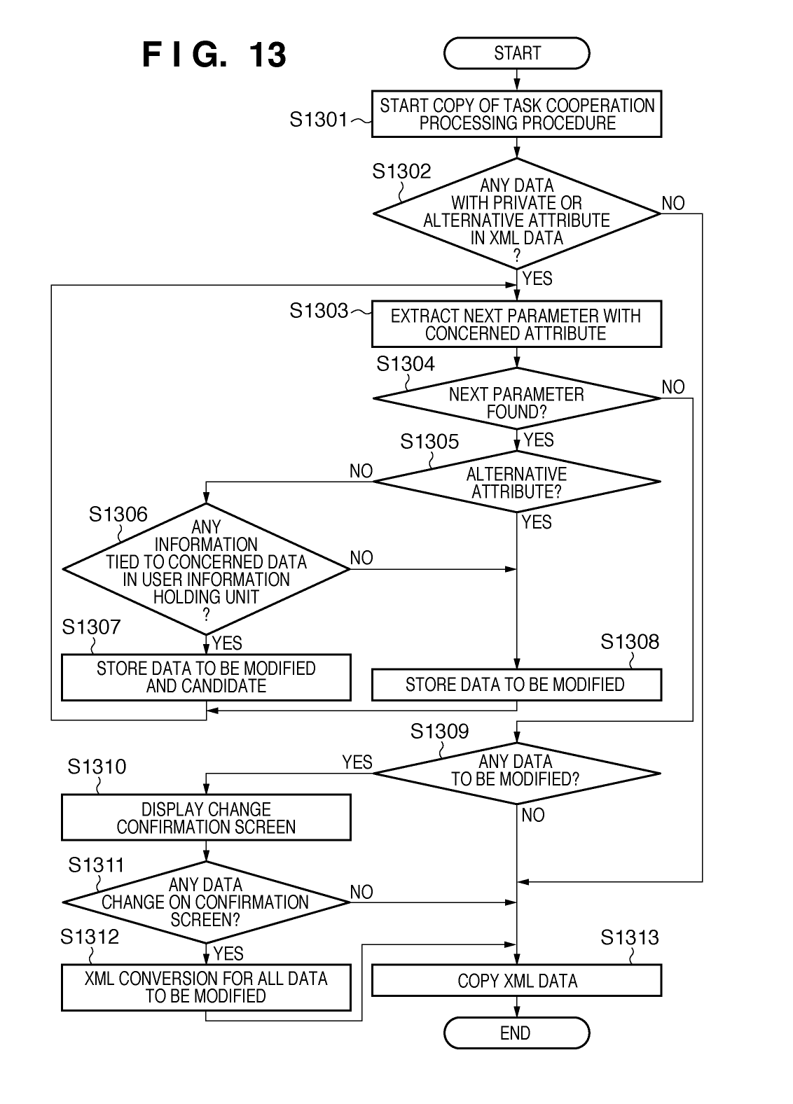

In step S1203, the CPU 601 copies the concerned task cooperation processing procedure into a user group. The copy process as described herein is to change parameters according to the request of the user 2 and store the task cooperation processing procedure including the changed parameters into the user 2's own user area. The detailed copy process will be described later with reference to FIG. 13.

Thereafter, the CPU 601 determines in step S1204 that the copy process has been completed. Then, in the case where the user 2 executes this task cooperation processing procedure in step S1205, the CPU 601 executes the “as-is” task cooperation processing procedure that has been copied in the user 2's user group. This allows the user 2 to execute the task cooperation processing procedure as expected.

Next, a procedure for the process of copying a task cooperation processing procedure according to the first embodiment will be described with reference to FIG. 13. The processing described below is under the centralized control of the CPU 601 of the image forming apparatus 510. First, in step S1301, the CPU 601 starts the copy process. This copy process is performed upon user instruction from the operation unit. The method for instructing copying may be a drag-and-drop method or a copying method using commands. Then, in step S1302, the CPU 601 determines whether or not the XML data to be copied includes any parameters that have either the “private” or “alternative” attribute, and detects the concerned parameters. If there is no such parameter, the process proceeds to step S1313, and if there is any such parameter, the process proceeds to step S1303. In step S1313, the CPU 601 copies the XML data including the “as-is” parameters into the user 2's “user group”, for example.

On the other hand, if any parameter that has either the “private” or “alternative” attribute has been detected, the CPU 601 extracts a parameter that has the concerned attribute in step S1303. Then, in step S1304, the CPU 601 determines whether or not any parameter has been extracted. Here, if any concerned parameter has been extracted, the process proceeds to step S1305, and if no concerned parameter has been extracted, it is determined that the processing from steps S1303 to S1308 has been completed for all concerned parameters, and the process proceeds to step S1309.

In step S1305, the CPU 601 determines whether or not the concerned parameter has the “alternative” attribute. If the parameter has the “alternative” attribute, the process proceeds to step S1308, in which the CPU 601 stores the concerned parameter into memory. On the other hand, if the concerned parameter has the “private” attribute, the process proceeds to step S1306, in which the CPU 601 determines whether or not a user information holding unit holds data that is tied to the concerned parameter. If there is no such data, the process proceeds to step S1308, and if there is any such data, the process proceeds to step S1307. The user information holding unit as described herein refers to a memory area that holds user-specific information. For example, an e-mail destination address (a parameter having the “private” attribute) is held being tied to user identification information.

In step S1308, the CPU 601 stores the concerned parameter into memory, and the process returns to step S1303. Meanwhile, in step S1307, the CPU 601 stores the tied data and the parameter into memory, and the process returns to step S1303. The above-described processing from steps S1303 to S1308 is repeated, and eventually if there is no more parameter that has the concerned attribute, the process proceeds to step S1309.

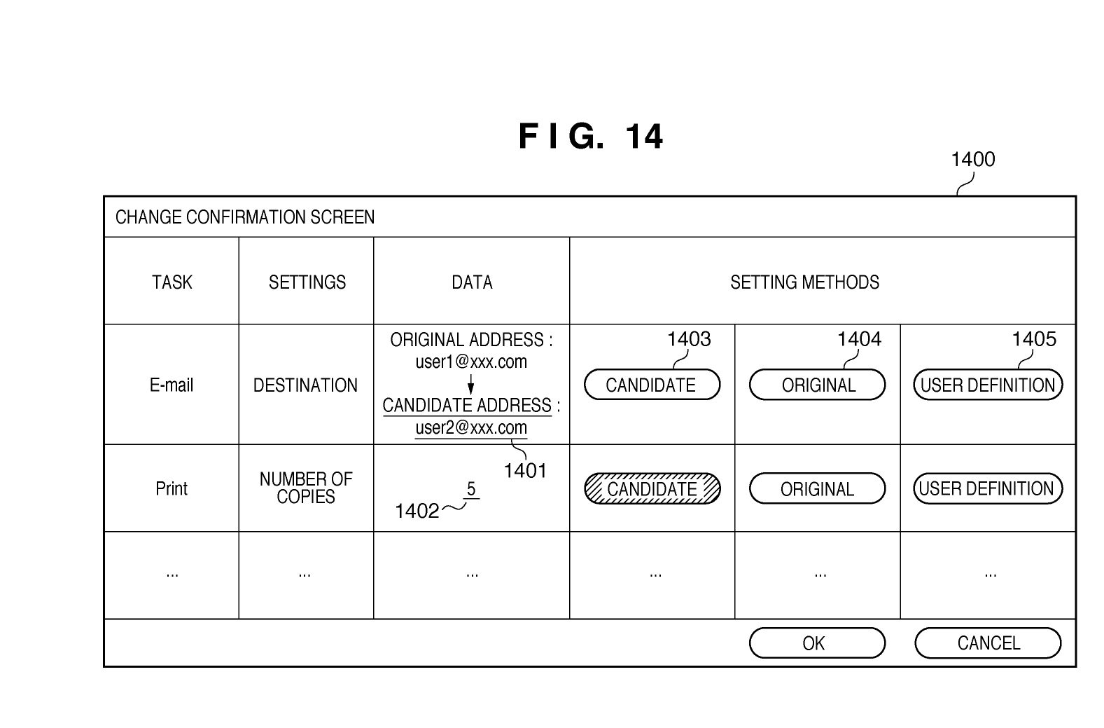

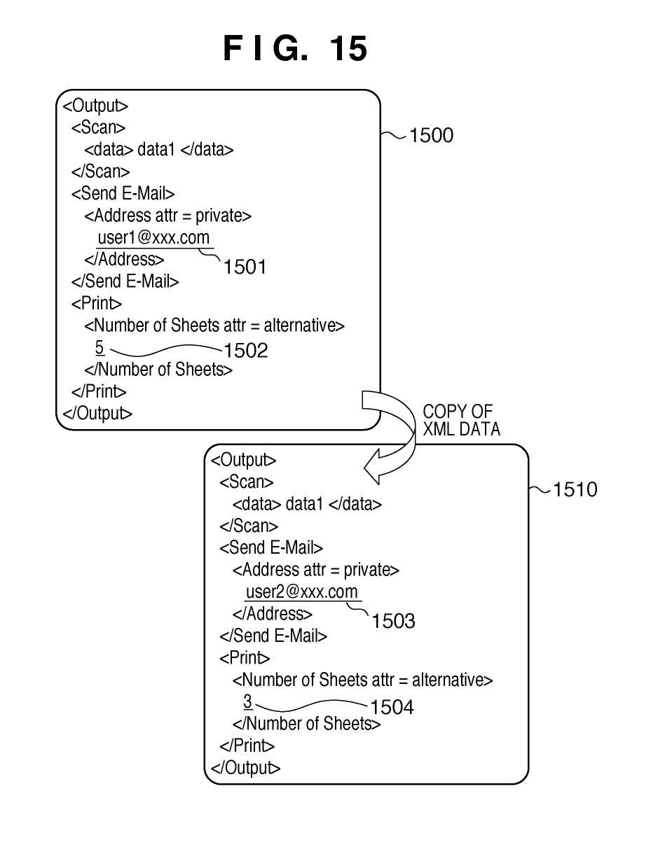

In step S1309, the CPU 601 determines whether or not there is any data to be modified. Specifically, it is determined whether or not there are any parameters that have an attribute stored in memory. If there is no such parameter, the process proceeds to step S1313, in which the CPU 601 copies the XML data including the “as-is” parameters into the user 2's “user group”, for example. On the other hand, if there is any such parameter, the process proceeds to step S1310, in which the CPU 601 causes the operation unit 511 to display a change confirmation screen as illustrated in FIG. 14 that prompts a user to confirm data that includes a change candidate.

Here, an example of the change confirmation screen 1400 according to the first embodiment will be described with reference to FIG. 14. As illustrated in FIG. 14, the change confirmation screen 1400 is configured to include a setting item, setting data, and a setting method for each task. Note that the change confirmation screen 1400 is one example of a change screen. If there is a change candidate, the CPU 601 causes a change candidate 1401 to be displayed on the change confirmation screen 1400. In the case where data has the “private” attribute and the user information holding unit holds no address data information that is tied to the user 2, or in the case where data has the “alternative” attribute, the CPU 601 causes only a copy-source value 1402 to be displayed with no candidate displayed.

The user also determines how to change the value of each parameter. In the case of using a change candidate as is, the user presses a candidate button 1403, and in the case of using originally defined data, the user presses an original button 1404. If the user wants to set user-defined data at this time, a user definition button 1405 is pressed.

After the change confirmation screen 1400 was displayed in step S1310, then in step S1311, the CPU 601 determines whether or not the user 2 has made any change to each parameter on the change confirmation screen 1400. If any change has been made to the data on the change confirmation screen 1400, the CPU 601 converts an XML data file 1500 into an XML data file 1510 in order to reflect specified changes as illustrated in FIG. 15. In the present conversion process, for example, the e-mail destination address is changed from a user 1's address 1501 to a user 2's address 1503, and the number of copies to be printed is changed from a value 1502 of “5” to a value 1504 of “3”.

Then, in step S1313, the CPU 601 copies the XML data into the user 2's “user group”. Here, if no change has been made to the data in step S1311, or if there is no data to be modified in step S1309, or if it is determined in step S1302 that there is no parameter that has a specified attribute, the XML data defined for the user 1 is copied without changing the definition. On the other hand, if any parameter in the XML data defined for the user 1 has been changed in step S1312, the converted XML data is copied into the user 2's “user group”.

As a result, the XML data that belongs to the user 2's user group and defines the copied task cooperation processing procedure will define parameters, the settings for which have been confirmed by the user 2. Accordingly, the user 2 can attain the processing result as expected at the time of executing the concerned task cooperation processing procedure. That is, in the information processing apparatus according to the present embodiment, in the case where a person who registers a task cooperation processing procedure differs from an executor of the procedure, a task cooperation processing procedure including changed parameters is copied into a specified area and executed, which allows the executor to attain the processing result as expected.

### Second Embodiment

Next, the second embodiment will be described with reference to FIGS. 12, 14, 16A, 16B and 17. The present embodiment describes the case where a specified task cooperation processing procedure is copied into a shared group in step S1202 of the flow chart in FIG. 12. Specifically, a case is assumed where, for the purpose of common use by multiple users, a third party with administrative rights copies the contents of a task cooperation processing procedure created by another user into a “shared group”, and a logged in user uses the copied task cooperation processing procedure. That is, a case where a person who registers a procedure differs from a user of the procedure is considered.

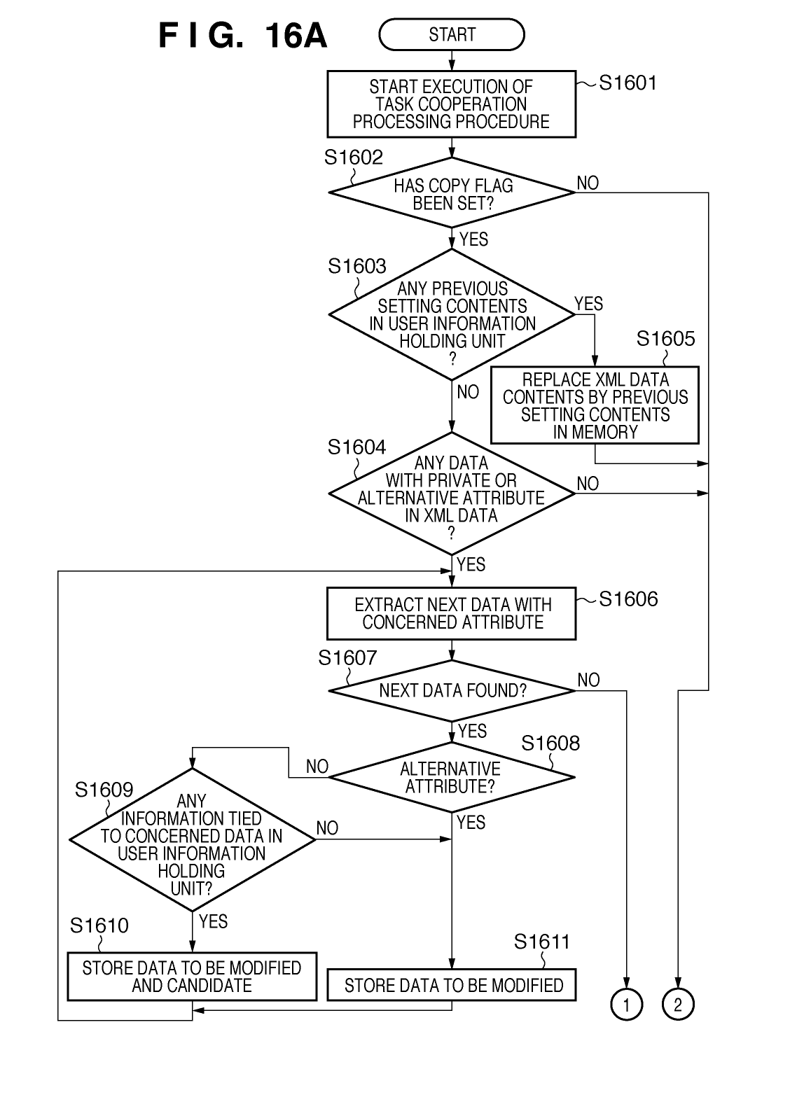

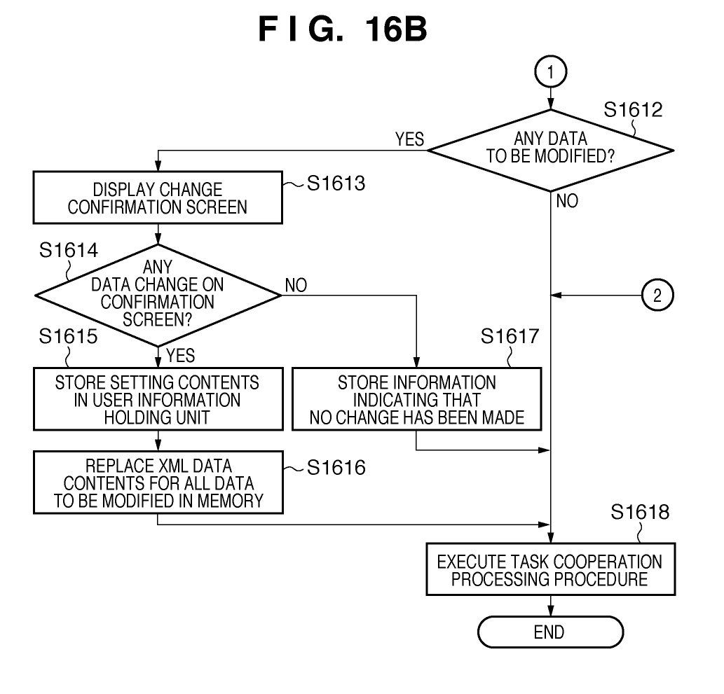

First, the flow chart in FIG. 12 is described. The present example describes the case where the copy destination of a task cooperation processing procedure is a shared group in step S1202. That is, only the processing from steps S1207 to S1210 is described herein. In step S1207, the CPU 601 appends a copy flag indicating the copy of the procedure to the XML data and copies the XML data into a “shared group”. Then, the CPU 601 determines in step S1208 that the copy has been completed. Thereafter, in step S1209, the CPU 601 accepts an instruction from a specified user to execute this task cooperation processing procedure. Upon an instruction to execute the concerned task cooperation processing procedure, in step S1210, the CPU 601 converts and then executes the concerned task cooperation processing procedure according to the user request. This execution process will be described below with reference to FIGS. 16A and 16B.

Next, a procedure for the process of executing a task cooperation processing procedure according to the second embodiment will be described with reference to FIGS. 16A and 16B. The processing described below is under the centralized control of the CPU 601 of the image forming apparatus 510. First, in step S1601, the CPU 601 starts the process of executing a task cooperation processing procedure. Then, in step S1602, the CPU 601 determines whether or not the copy flag has been set for the concerned task cooperation processing procedure. If the copy flag has not been set, for example, if the copy flag has a value of “0”, the process proceeds to step S1618, in which the task cooperation processing procedure is executed as defined. Thus, in the case where the copy flag has not been set, the original task cooperation processing procedure is executed without changing parameters.

Meanwhile, if it is determined in step S1602 that the copy flag has been set, for example, if the copy flag has a value of “1”, the process proceeds to step S1603. In step S1603, the CPU 601 determines whether or not the user information holding unit for holding user-specific information holds any setting parameters that might have been set previously at the time of executing this task cooperation processing procedure. In general, if this is the first time execution of this task cooperation processing procedure, there are not such setting parameters, so the process proceeds to step S1604. For a second or later execution, setting contents may remain, so in that case, the process proceeds to step S1605. In step S1605, the CPU 601 converts the task cooperation processing procedure based on the previously set setting parameters, and then the process proceeds to step S1618, in which the task cooperation processing procedure is executed.

In step S1604, the CPU 601 determines whether or not there are any parameters that have either the “private” or “alternative” attribute in the XML data to be executed. Here, if there is no such parameter, the process proceeds to step S1618, in which the task cooperation processing procedure is executed.

On the other hand, if there is any such parameter, the process proceeds to step S1606, in which the CPU 601 extracts any parameter that has the specified attribute. Then, in step S1607, the CPU 601 determines whether or not any parameter has been extracted. If any parameter has been extracted, the process proceeds to step S1608, and if no parameter has been extracted, it is determined that the processing from steps S1606 to S1611 has been executed for all concerned parameters, and the process proceeds to step S1612.

In step S1608, the CPU 601 determines whether or not the concerned parameter has the “alternative” attribute. If the parameter has the “alternative” attribute, the process proceeds to step S1611, in which the CPU 601 stores the concerned parameter into memory. On the other hand, if the parameter has the “private” attribute, the process proceeds to step S1609, in which the CPU 601 determines whether or not the user information holding unit holds data that is tied to the concerned parameter. If there is no such data, the process proceeds to step S1611, in which the CPU 601 stores the concerned parameter into memory. If there is any such data, on the other hand, the process proceeds to step S1610, in which the CPU 601 stores the tied data and the parameter as a candidate. The above-described processing from steps S1606 to S1611 is repeated, and eventually if there is no more parameter that has the concerned attribute, the process proceeds to step S1612.

In step S1612, the CPU 601 determined whether or not there is any parameters that have an attribute to be changed. Here, if there is no such parameter, the process proceeds to step S1618, in which the task cooperation processing procedure is executed. On the other hand, if there is any such parameter, the process proceeds to step S1613, in which the CPU 601 displays the change confirmation screen 1400 that prompts a user to confirm data including the abovementioned change candidate.

Then, in step S1614, the CPU 601 determines whether or not the user has made any change to the data on the change confirmation screen 1400. Here, if any change has been made, the process proceeds to step S1615, and if no change has been made, the process proceeds to step S1617. The change confirmation screen 1400 has already been described in the first embodiment, so it will not be described herein.

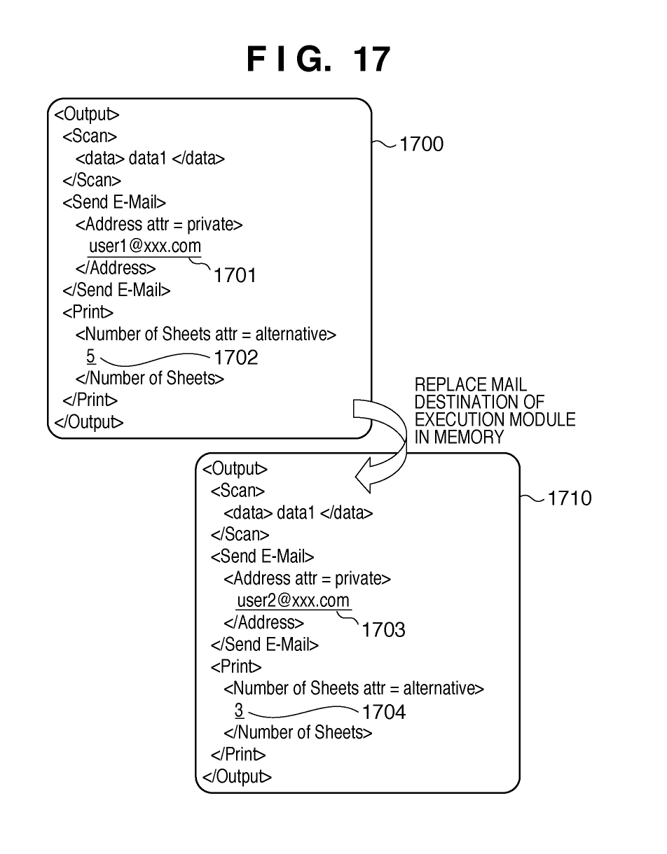

In step S1615, the CPU 601 stores the changed setting contents into the user information holding unit. By this, a second and later determination in step S1603 will end in the result that there is a history of setting contents. Subsequently, the process proceeds to step S1616, in which the CPU 601 converts an XML data file 1700 into an XML data file 1710 in order to reflect the contents changed by the user as illustrated in FIG. 17. For example, the e-mail destination address is changed from a user 1's address 1701 to a user 2's address 1703, and the number of copies to be printed is changed from a value 1702 of “5” to a value 1704 of “3”. Note that the conversion process as described herein is performed in the memory of an execution module of the task cooperation processing procedure. That is, this conversion is performed only in memory, so it does not mean the conversion of the XML data that defines the task cooperation processing procedure copied in the shared group.

Thereafter, the process proceeds to step S1618, in which the CPU 601 executes the task cooperation processing procedure using the changed parameters. If no change has been made to the data in step S1614, the process proceeds to step S1617, in which the CPU 601 stores information indicating that no change has been made to the setting contents, into the user information holding unit. Thereafter, in step S1618, the CPU 601 executes the task cooperation processing procedure.

As described above, in the information processing apparatus according to the present embodiment, in the case where a person who registers a task cooperation processing procedure differs from an executor of the procedure, parameters are changed before execution of the task cooperation processing procedure copied in the shared group. This allows the executor to attain the processing result as expected.

### Third Embodiment

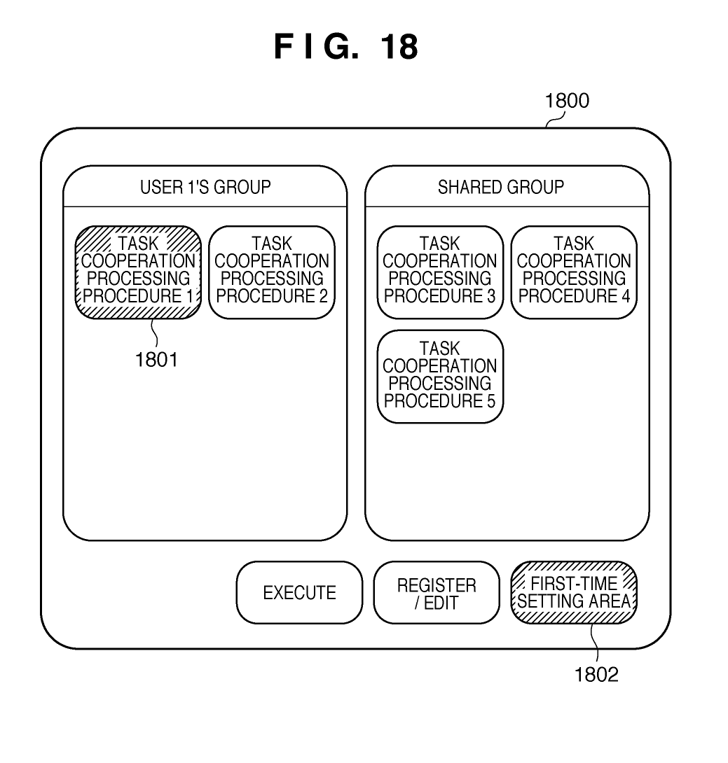

Next, a third embodiment will be described with reference to FIG. 18. In the second embodiment, setting contents are basically fixed at the first execution of a task cooperation processing procedure and stored in the user information holding unit. Thus, in step S1605 of FIG. 16A, the task cooperation processing procedure is executed based on the fixed setting contents. However, in some cases, a user may want to change setting contents for each execution. Thus, the present embodiment describes a configuration that deletes setting contents stored in the user information holding unit. With this configuration, there is no case where the process proceeds to step S1605 after the determination in step S1603 at the time of re-execution of a task cooperation processing procedure, and instead, the change confirmation screen 1400 is displayed. That is, this produces the same state as the first execution in the second embodiment, thus allowing a user to execute a procedure after again confirming the settings.

As illustrated in FIG. 18, a setting screen 1800 is displayed on the operation unit 511 of the image forming apparatus 510. The setting screen 1800 includes selection buttons such as 1801 for selecting a task cooperation processing procedure that belongs to each user group, and a first-time-settings clear button 1802 for deleting the settings for a task cooperation processing procedure. With the press of the selection button 1801, a user may select a task cooperation processing procedure, and with the press of the first-time-settings clear button 1802, a user may delete setting contents tied to the selected cooperation processing procedure. Specifically, with the abovementioned user operation, the image forming apparatus 510 deletes concerned setting contents from the user information holding unit that holds setting contents for task cooperation processing procedures.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-118039 filed on May 14, 2009, which is hereby incorporated by reference herein in its entirety.

What is claimed is:

1. An information processing apparatus comprising:
a registration unit that registers a process flow for executing predetermined processing according to a predefined set value, the process flow being registered as a process flow that is usable by a specific user or a process flow that is commonly usable by a plurality of users;
a changing unit that changes the process flow that is usable by the specific user to the process flow that is usable by the plurality of users; and
a control unit that, when the changing unit changes the process flow, prompts a user to change the set value to another set value.

2. An information processing apparatus comprising:
a registration unit that registers a process flow for executing predetermined processing according to a predefined set value, the process flow being registered as a process flow that is usable by a specific user or a process flow that is commonly usable by a plurality of users;
a changing unit that changes the process flow that is usable by the plurality of users to the process flow is usable by the specific user; and
a control unit that, when the changing unit changes the process flow, prompts a user to change the set value to another set value.

3. An information processing apparatus comprising:
a registration unit that registers a process flow for executing predetermined processing according to a predefined set value, the process flow being registered as a process flow that is usable by a first user or a process flow that is usable by a second user;
a changing unit that changes the process flow that is usable by the first user to the process flow that is usable by a second user; and
a control unit that, when the changing unit changes the process flow, prompts a user to change the set value to another set value.

4. The information processing apparatus according to claim 1, wherein, when the changing unit registers the process flow, the control unit prompts a user to change the set value to another set at the time of executing the predetermined processing.

5. The information processing apparatus according to claim 1, wherein
the predetermined processing is processing using a plurality of predefined set values, and
the control unit prompts the user to change a set value that have a predetermined attribute among the plurality of predefined set values, and does not change a set value that does not have the predetermined attribute among the plurality of predefined set values.

6. The information processing apparatus according to claim 1, further comprising:
a display unit that displays a screen,
wherein, when the changing unit changes the process flow, the control unit causes the display unit to display a change screen for changing the set value that is used for the predetermined processing to be executed, and changes the set value according to an instruction accepted on the displayed change screen.

7. The information processing apparatus according to claim 1, further comprising:
a display unit that displays an operation screen for operating the information processing apparatus,
wherein the display unit displays, on the display unit, a button for causing the information processing apparatus to execute the process flow.

8. The information processing apparatus according to claim 1, wherein
the predetermined processing is data transmission processing, and
the set value is a data transmission destination in the data transmission processing.

9. A method for controlling an information processing apparatus, comprising:
registering a process flow for executing predetermined processing according to a predefined set value, the process flow being registered as a process flow that is usable by a specific user or a process flow that is commonly usable by a plurality of users;
changing the process flow that is usable by the specific user to the process flow that is usable by the plurality of users;
prompting, when the process flow is changed, a user to change the set value to another set value.

10. A method for controlling an information processing apparatus, comprising:
registering a process flow for executing predetermined processing according to a predefined set value, the process flow being registered as a process flow that is usable by a specific user or a process flow that is commonly usable by a plurality of users;
changing the process flow that is usable by the plurality of users to the process flow is usable by the specific user an instruction unit that has been stored in the storage unit as an instruction; and
prompting, when the process flow is changed, a user to change the set value to another set value.

11. A method for controlling an information processing apparatus, comprising:
registering a process flow for executing predetermined processing according to a predefined set value, the process flow being registered as a process flow that is usable by a first user or a process flow that is usable by a second user;
changing the process flow that is usable by the first user to the process flow that is usable by a second user; and
prompting when the process flow is changed, a user to change the set value to another set value.

12. A computer-readable storage medium storing a computer program for causing a computer to perform the method for controlling an information processing apparatus according to claim 9.
